(19) United States
(12) Patent Application Publication
(10) Pub. No.: US 2008/0218042 A1
(43) Pub. Date: Sep. 11, 2008

(54) Kit for Producing a Frame Superstructure for Switchgear Cabinets

(76) Inventors: Marc Hartel, Reiskirchen (DE); Ralf Dahmer, Olpe (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/586,574

(22) PCT Filed: May 29, 2004
(86) PCT No.: PCT/EP2004/005860

§ 371 Date: Jul. 19, 2006

(30) Foreign Application Priority Data
Feb. 13, 2004 (DE) 202004002351.2

(51) Int. Cl. H02B 1/01; A47B 47/00; H02B 11/12; A47F 5/00

(52) U.S. Cl. 312/265.4; 211/189; 361/608

(57) ABSTRACT

A kit for producing a frame superstructure for switchgear cabinets including a cupboard frame having four horizontal width struts, four horizontal depth struts and four vertical frame legs having a predetermined width, depth and height. A vertical frame includes two horizontal width struts and two vertical frame profiles which are insertable into in the cupboard frame and connectable to the depth struts thereof. Covering elements are connectable in the form of external and internal elements to two vertical frames which are spaced so that an independent base frame is formed. At least one cupboard door is pivotally fixable to the covering elements. This invention makes it possible to obtain a great number of embodiments with several simple elements.

### BACKGROUND OF THE INVENTION

1. Field of the Invention

This invention relates to a kit for producing frame structures for switchgear cabinets.

2. Discussion of Related Art

Racks for switchgear cabinets are known in various structural sizes, in regard to width, depth and height. Twelve racks, sections of a profiled continuous strand, can be connected with each other in the four corner areas of the rack with corner connectors, to form a fixed or releasable frame structure.

As European Patent Reference EP 0 076 819 A shows, four vertical profiled frame elements can be connected with each other to form a frame structure with a cover as a bottom unit and a cover as a top unit. In this case, the frame structure with the fastening receivers of the vertical profiled frame elements makes possible the installation of additional mounting rails.

In known frame structures, the installation requirements very definitely dictate the design of the frame legs used.

### SUMMARY OF THE INVENTION

It is one object of this invention to provide a kit for placement in frame structures for switchgear cabinets, which includes a few simple components and yet can be matched to most varied installation requirements.

To attain this object, a kit according to this invention has a cabinet rack made of four horizontal broad struts, four horizontal depth struts, as well as four vertical frame legs of a preset width, depth and height. There are plate-shaped cover elements, which have on two opposite sides fastening edges beveled at right angles with at least one row of fastening receivers. Vertical frames made of two vertical profiled frame elements and two horizontal broad frame struts can be installed in the cabinet rack, wherein they can be connected with the depth struts, or can be attached at different spacings by base profiled sides of the vertical profiled frame elements to the insides of the fastening edges of the cover elements and, with cover elements used as a bottom element and a top element, and can form an independent basic rack. At least one cabinet door, which is beveled on its circumference and can be hinged to the cover elements.

The cabinet rack alone can be used in a known manner for the installation of different built-in devices, and can be closed off by a cabinet door and panel elements.

It is also possible to install two vertical frames in the cabinet rack, which are used, for example, for installing 19″ built-ins of different installation depth.

Finally, two such vertical frames with two cover elements can be connected to form an independent basic rack, in which the built-ins can be installed, wherein a simple adaptation to different installation depths of the built-ins is possible. This independent basic rack can be combined by a cabinet door and vertical lateral panel elements into a basic rack which can be matched to quite different installation requirements and can be completed to form an entirely independent switchgear cabinet. It is thus possible with two additional simple components to considerably increase the variation options for producing frame structures, and thus to considerably reduce the storage of switchgear cabinets for varied installation conditions.

In this case, the cabinet rack as a component of the kit can be designed so that the broad struts, the depth struts and the frame legs of the cabinet rack are formed as sections of respectively identical profiled elements, which are fixedly connected with each other, for example welded together, in corner areas of the cabinet rack by corner connectors. However, the design can also be such that the broad struts and the depth struts of the cabinet rack form a solid bottom frame and a solid cover frame. The vertical frame legs can be attached in the corner areas of the bottom frame and the top frame and form, together with the corner connectors and the bottom and top frames, a continuous exterior receiver.

In accordance with one embodiment, the structural units of the kit are designed as a vertical frame. The vertical profiled frame elements of the vertical frames have a profiled base side with at least one row of fastening receivers, which terminate with the front faces of the horizontal broad vertical struts. The lateral legs are beveled off on both sides of the profiled base side, which are oriented to the longitudinal sides of the associated horizontal broad frame struts of the vertical frames and are connected with them. In this case, the vertical profiled frame elements of the vertical frame can be designed so that at least one row of identical fastening receivers is cut in a uniform aligned graduation into the profiled base side and the beveled lateral legs of the vertical profiled frame elements of the vertical frames, or at least one row of equal or identical fastening receivers is cut in the same or a different graduation into, respectively, the profiled base side and in the beveled lateral legs of the vertical profiled frame elements of the vertical frames.

The structural unit of the vertical frames has sufficient sturdiness and torsional rigidity, and thus a permanent alignment of the parts of the vertical frame, if the horizontal broad frame struts and the vertical profiled frame elements of the vertical frames are fixedly connected with each other in the corner areas, for example welded together.

So that two vertical frames together with two cover elements can be connected in a simple manner into a basic rack, in one embodiment, on two facing sides the plate-shaped cover elements have fastening edges, which are beveled at right angles and have at least one row of fastening receivers. The vertical profiled frame elements of two vertical frames can be connected by profiled base sides with the insides of the fastening edges of the cover elements at different spacings to form a basic rack.

An installation of the vertical frames into a structural unit formed as a cabinet rack is simplified if the horizontal broad frame struts of the vertical frames have cable guide openings, and if the two vertical frames can be connected via fastening receivers of the horizontal broad frame struts with the facing tops of the horizontal depth struts of the cabinet rack at different distances from each other.

If the vertical frames are parts of a basic rack, for the introduction of cables via the bottom element or the top element, the base plates of the cover elements have cable introduction recesses in the basic rack above the horizontal broad frame struts of the vertical frames.

In one design for attaching lateral walls and a cabinet door to the basic rack, the fastening edges of the cover elements have connecting strips beveled toward the exterior on their free edges, and protrude beyond the base plate of the cover elements over the fastening edges and together with the connecting strips form receivers for attaching lateral walls on the basic rack. The base plates of the cover elements protrude at the sides extending perpendicularly with respect to the fastening edges and have bevels, on which a cabinet door can be hinged and locked, and a rear wall can be fastened.

The construction of the cabinet rack can be simplified if the base plates of the cover elements have a center opening and with fastening bores in the corner areas. In this case, the attachment of the vertical frame legs at the bottom frame and the top frame is solved if the vertical frame legs of the cabinet rack have a profiled element with a plug-in connection for the plug-in element of the corner connectors, and together with the exterior contour, the profiled element forms the exterior receptacle, which is designed symmetrical with respect to the diagonal plane of the bottom and top frames. Thus, the exterior receptacle in the corner areas of the cabinet rack can be maintained over the entire height of the cabinet rack. The bottom and the top frames of the cabinet rack have corner receivers, into which the corner connectors can be placed with a filler element and connected with the bottom or top frame. With their exterior contour, the filler elements of the corner connectors extend the exterior receptacles of the vertical profiled frames of the cabinet rack past or beyond the bottom frames and the top frames.

In case of an asymmetric cross section with interchanged front sides, the vertical frame legs can be supportingly fastened at the bottom frame or the top frame if the front sides of the vertical profiled frame elements of the cabinet rack are connected in an upright manner with the facing sides of the bottom and of the top frames and the filler elements of the corner connectors.

The vertical frame legs of the cabinet rack can be used for bringing in connection and junction cables because the vertical profiled frame elements of the cabinet rack form a channel, open to the interior of the cabinet rack, between the bottom and the top frames, which can be closed by a profiled box. The profiled box has vertical channels and rows of bores in the cover wall. In this case, the profiled box can close off channels of the vertical frame legs of the cabinet rack which are not used. Closing the channel becomes optimal if the cover wall of the profiled box covers the channel in the vertical profiled frame elements of the cabinet rack with covering strips.

There are other fastening possibilities at the vertical frame legs of the cabinet rack if the profiled side of the vertical profiled frame section forming the channel supports connecting strips are formed on the exterior of the free profiled side.

In one embodiment of this invention, the cabinet door has a beveled edge, receiving hinge elements with hinge bolts, which can be inserted into bearing receivers of the cover elements of the basic rack, in the corner areas of the hinge side of the cabinet door. The hinge bolts are adjustable in an axially limited manner in the hinge elements and can be fixed on the bevel of the cover elements so they do not shift, at least in the position in which they are engaged with the facing bearing receiver or bearing bushing.

In this case, the hinge elements which can be attached to the rack for hinging the cabinet door become superfluous, because their function is taken over by the bearing receivers at the bevels of the cover elements of the rack. Only the counter-hinges with the hinge bolts to be attached to the cabinet door are required. The hinge elements permit easy mounting/removal of the cabinet door at the rack.

The rack makes the hinging of the cabinet door easier because the end edges of the fastening edges of the cover elements are set back in relation to the beveled edges, at a minimum by an amount which at least corresponds to the dimensions of the first door bevel directed perpendicularly to the door leaf. A receptacle is thus created at the rack, which can receive the cabinet door pivotably.

The rotary seating of the hinge bolts fixed in the hinge elements can be improved easily if bearing bushes are inserted into the bearing receivers in the beveled edges of the cover elements.

If bearing receivers or bearing bushes are provided in the two end areas of the beveled edges of the cover elements, the lock side of the cabinet door has displaceable locking bars, which can be shifted manually or by a rod closing device and can be inserted into or moved out of the bearing receivers or bearing bushes of the beveled edges of the cover elements of the rack.

In one embodiment of this invention, the bearing receivers are designed as bearing bushes, which are arranged on facing fold areas of the double-walled edges. A stable connecting point for the door hinges is thus created. At the front, the fold forms a rounded end of the cover element, which is visually attractive and prevents the danger associated with a cutting injury. Thus, the bearing receivers can be designed as bearing bushes, which are arranged on facing fold areas of the double-walled edges. The functionality of the double-walled edge can be extended if at least one of the double-walled edges has a bevel, which protrudes as a door stop in the direction toward the respectively oppositely located cover element.

### BRIEF DESCRIPTION OF THE DRAWINGS

This invention is explained in view of an embodiment represented in the drawings, wherein:

FIG. 1 shows a vertical frame as a first component of a kit, in a perspective plan view;

FIG. 2 is a perspective partial plan view of a corner area of the vertical frame, as shown in FIG. 1;

FIG. 3 shows an enlarged perspective plan view of a cover element used as a bottom element as the second component of the kit;

FIG. 4 shows an exploded view of the corner area of a bottom frame with a corner connector and a vertical frame leg of a cabinet rack as the third component of the kit;

FIG. 5 is a partial perspective view of the vertical frame leg with a channel, which can be closed by a profiled box;

FIG. 6 shows a perspective view of the lower portion of the cabinet rack with two installed vertical frames, in accordance with FIG. 1;

FIG. 7 shows a perspective plan view of a basic rack having two vertical frames in accordance with FIG. 1 and two cover elements in accordance with FIG. 3;

FIG. 7b shows a perspective view of an alternative design detail of the cover element;

FIG. 8 shows a perspective view of a basic rack with lateral walls and a hinged-on cabinet door;

FIG. 9 shows a perspective detailed view with the lower corner area of the rack and switchgear cabinet with the hinged-on cabinet door; and

FIG. 10 is a sketch of the partial view shown in FIG. 9 but without a cabinet door.

### DETAILED DESCRIPTION OF THE INVENTION

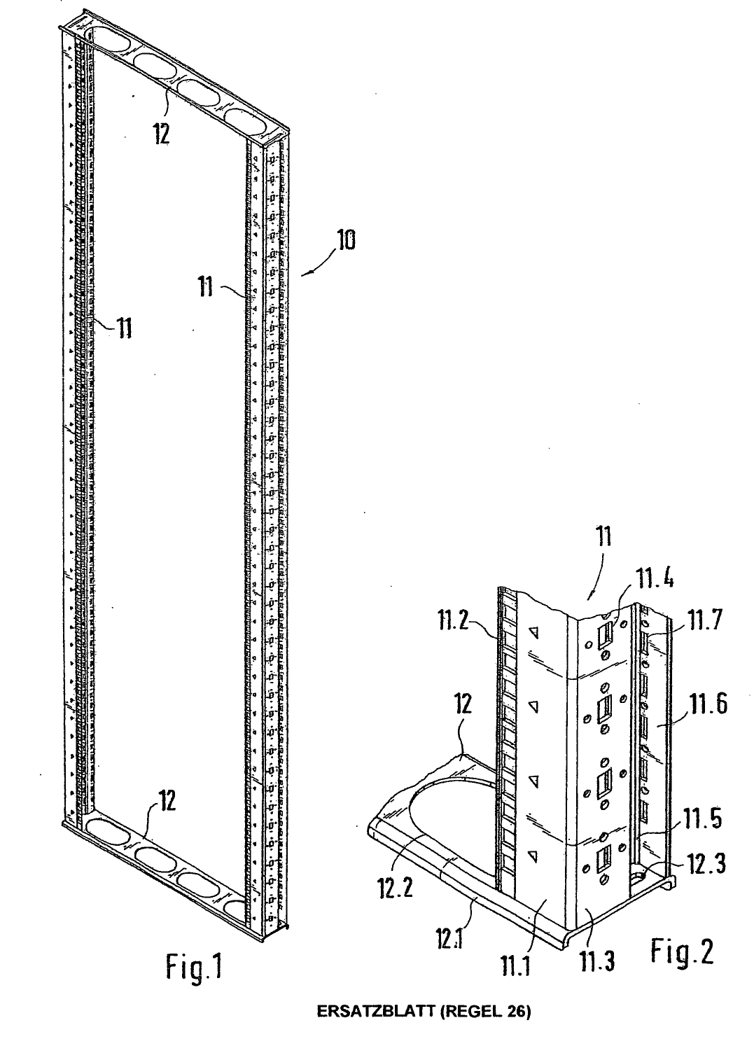

The vertical frame 10 shown in FIG. 1 forms the first component of the kit and comprises two vertical profiled frame elements 11 and two horizontal broad frame struts 12. In this case, the two profiled frame elements 11 with the facing profiled sides 11.1 (FIG. 2) with rows of fastening receivers 11.2 form a fastening level, for example for 19″ installations. In the area of or near their front sides, the profiled frame elements 11 are fixedly connected with the ends of the broad frame struts 12, for example are welded. The profiled sides 11.1 of the profiled frame elements extend parallel in relation to a longitudinal edge of the broad frame struts 12, while the profiled sides 11.3 terminate at the front ends of the broad frame struts 12. Finally, the profiled sides 11.6 terminate at the other longitudinal edges of the broad frame struts 12. The profiled sides 11.3 and 11.6 have at least one row of fastening receivers 11.4 and 11.7. So that the two vertical profiled frame elements 11 can be identically designed in spite of their asymmetric cross section and used for the vertical frame 10, they are attached with interchanged front faces to the broad frame struts 12.

The broad frame struts 12 can have cable introduction openings 12.2 and can be reinforced at the longitudinal edges with beveled edges 12.1. Also, the broad frame struts 12 can have fastening receivers 12.3 in the area of or near their front sides, such as shown in the partial perspective view in accordance with FIG. 2.

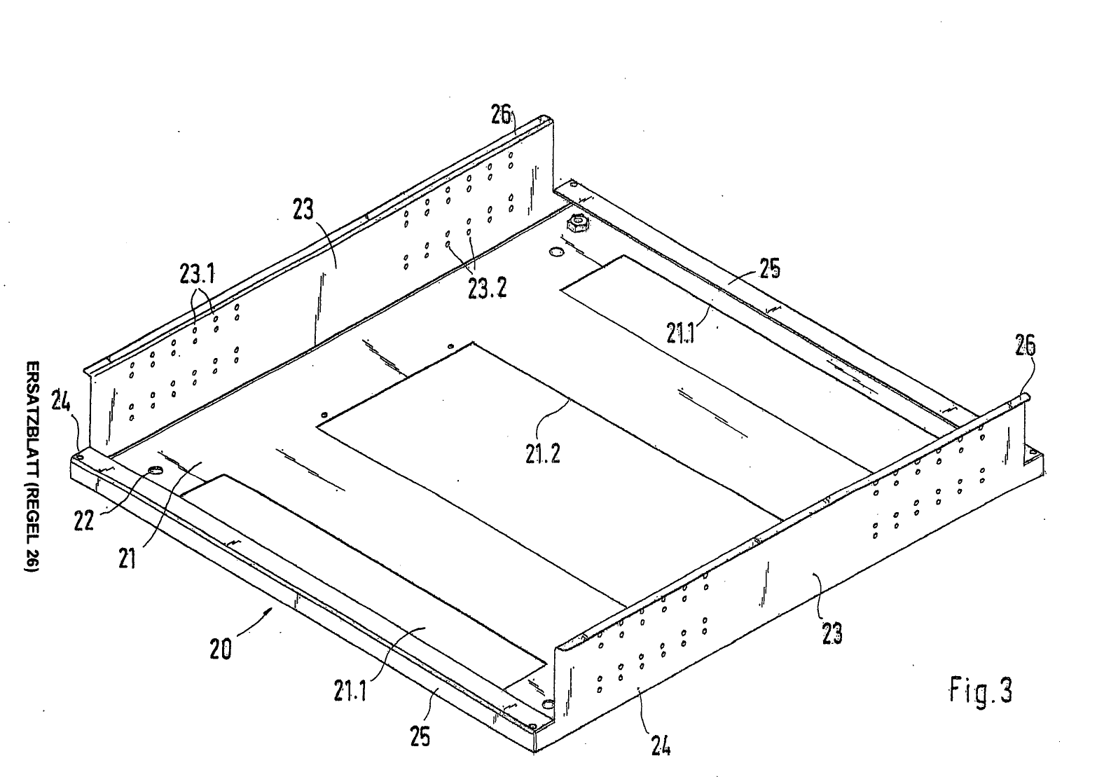

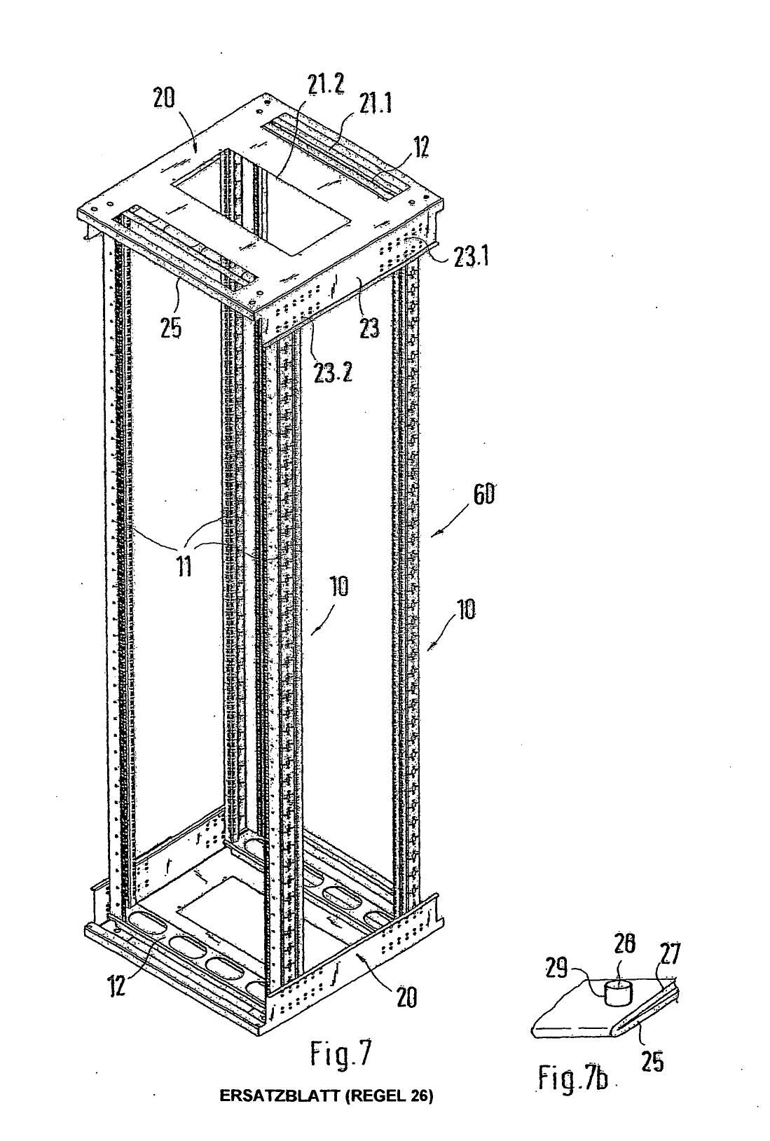

A cover element 20 is represented in an enlarged perspective view in FIG. 3, which is designed to be symmetrical in relation to the central longitudinal plane, which extends parallel with the beveled fastening edges 23, so that the cover element 20 can be used as a bottom element, as well as a top element for a basic rack 60, in accordance with FIG. 7. In this case, the fastening edges 23 are oriented toward each other. The fastening edges 23 support two rows of fastening receivers 23.1 and 23.2. The distance between the insides of the two fastening edges 23 of a cover element 20 corresponds to the exterior dimension of the profiled sides 11.3 of the two profiled frame elements 11 of a vertical frame 10, so that the vertical frame 10 can be connected via these profiled sides 11.3 with fastening receivers 11.4 with the insides of the fastening edges 23 of the cover elements 20. In this case, a lower cover element 20 as the bottom element, and an upper cover element 20 as the top element, connect two spaced-apart vertical frames 10 to form a basic rack 60, as shown in FIG. 7. Here, the profiled sides 11.1 can be arranged on the sides facing away from each other of the vertical frames 10. This can be easily achieved by a rotation of the second vertical frame 10 by 180°.

The cover element 20 has a base plate 21 with cable introduction openings 21.1 which, with the basic rack 60 completed, overlap the cable introduction openings 12.1 of the broad frame struts 12 of the vertical frame 10. Also, the base plate 21 of the cover element 20 can have a center opening 21.1, and fastening bores 22 in the corner areas.

The edge areas of the base plate 21 have bevels 25, which protrude past or beyond the front faces of the fastening edges 23 and simplify the attachment of a rear wall and a cabinet door at the basic rack 60. The base plate 21 of the cover element 20 also protrudes from the exteriors of the fastening edges 23 and forms a receptacle 24 with it, which makes the attachment of lateral walls on the basic rack 60 easier. In this case, it is also possible to use outwardly beveled connecting strips 26 at the free edges of the fastening edges 23. The cover element 20 can be produced in a simple manner and cost-effectively as a stamped-and-bent sheet metal element.

The construction of a further component of the kit is explained in view of FIGS. 4 to 6, namely a cabinet rack 30, which is laid out in accordance with a preset size in width, depth and height.

Here, the cabinet rack 30 comprises identical bottom frames and top frames 35 with four vertical frame legs 33. The identical frames are each put together from two horizontal broad struts 31 and two horizontal depth struts 32. The struts which meet in the corner areas of the frames 35 are fixedly connected with each other and form corner receivers 35.1. The struts 31 and 32 have horizontal and vertical profiled sides with rows of fastening receivers 31.1 and 32.1, which preferably differ from the fastening receivers 11.2 of the vertical frames 10. Corner connectors 40 are inserted into the corner receivers 35.1 of the frames 35 and are screwed together with the frame so that a filler element 40.1 of the corner connector 40 fills the corner receiver 35.1 in such a way that the filler element 40.1 terminates flush with the horizontal profiled sides of the struts 31 and 32, and the vertical frame leg 33 is pushed on and can be supported by the plug-in element 40.2.

As FIG. 4 shows, the plug-in element 40.2 is matched to the cross section of a hollow space 33.3 in the profiled element 33.1 of the vertical frame leg 33. With the outer contour, the profiled element 33.1 forms an outer receptacle 36 which is symmetrical with respect to the diagonal line of the corner receiver 35.1 which is continued over the filler element 40.1 of the corner connector 40 and simplifies the attachment of sheathing elements of the cabinet rack 30.

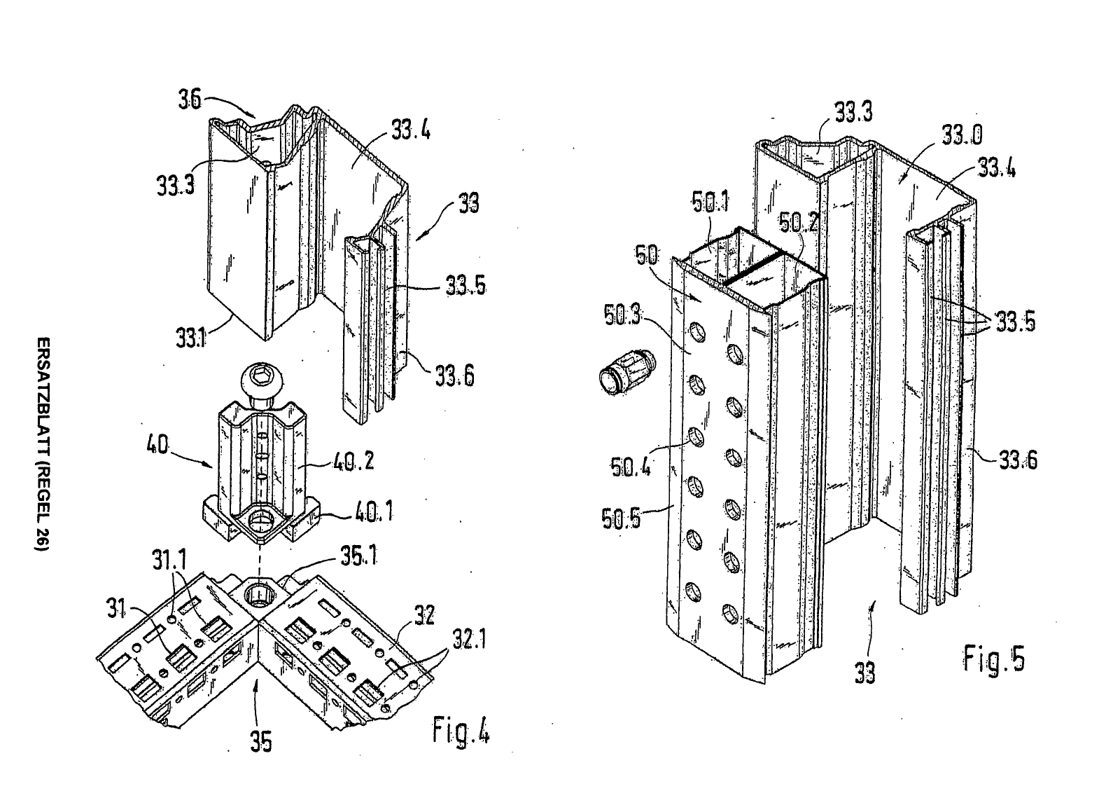

As FIGS. 4 and 5 show, a profiled element 33.4 follows the profiled element 33.1, which forms a channel 33.0 open toward the interior of the cabinet rack 30. The channel 33.0 can be used as a cable conduit and if not needed, it can be closed off by a profiled box 50 with cable conduits 50.1 and 50.2 and a closing wall 50.3. The closing wall 50.3 has rows of bores 50.4 and covers the channel 33.0 of the vertical frame leg 33 with covering strips 50.5.

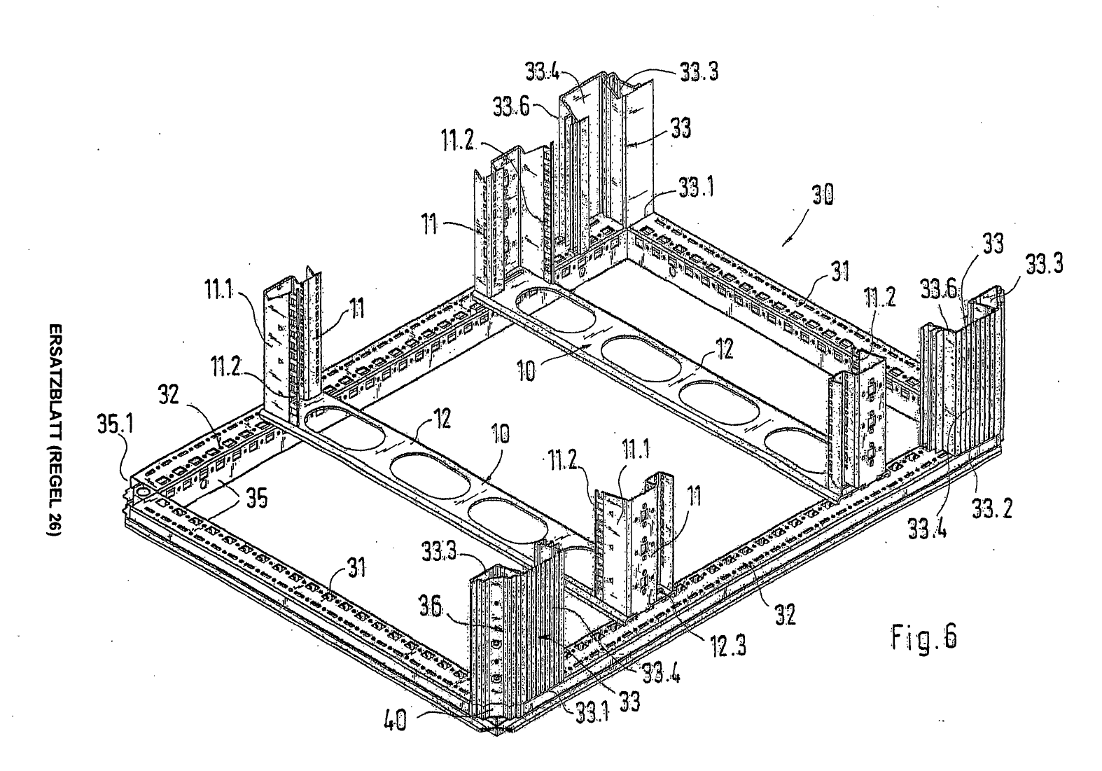

As shown in FIG. 6, the vertical frame legs 33 are fastened with interchanged front sides 33.1 and 33.2 at the frame 35, so that at the cabinet rack 30 the profiled elements 33.4 terminate flush with the depth struts 32 and face each other. This is possible, in a simple manner, by an appropriate turning and exchange of the front sides 33.1 and 33.2 of the four vertical frame legs 33 and leads to the cabinet rack 30 indicated in FIG. 6, whose upper top area is simply constructed in the opposite way.

Two spaced-apart vertical frames 10 are fastened by the depth struts 32 of the lower and upper frame 35. In this case, the vertical frames 10 with the profiled sides 11.1 and their fastening receivers 11.2 are arranged on sides of the vertical frame 10 facing away from each other and that are placed at a defined distance.

The cabinet rack 30 with two frames 35 and four vertical frame legs 33 installed in accordance with FIG. 6 can be laid out without or with built-in vertical frames 10. The vertical frames 10 are connected with the depth struts 32 of the frames 35 via the fastening receivers 12.3 of the broad frame struts 12. The height of the vertical frames 10 is determined by an interior distance between the two frames 35.

The basic cabinet rack 60 of the switchgear cabinet is shown in a perspective plan view in FIG. 7, which is put together from two plate-shaped horizontal cover elements 20 and two vertical frames 10. In this case, the vertical profiled frame elements 11 can have different profiled sides with rows of fastening receivers.

The vertical frames 10 are fastened at a distance from each other at beveled and facing fastening edges 23 of the cover elements 20, wherein the fastening edges 23 have at least one row of fastening receivers 23.1, or elongated holes extending in the direction of the cabinet depth. In this case, the vertical profiled frame elements 11 can be set back with respect to the edges 23.1 (see FIG. 10) of the fastening edges 33. The edges of the cover elements 20 extending perpendicularly with respect to the fastening edges 23 are beveled in an L-shape, so that edges 25, 27 are created, which are double-walled with the base plate 21 of the cover element 20. This edge can also be closed by a third beveled section. The fastening edges 23 have shoulders of the edges 23.1, which laterally cover the beveled edges 25, 27. The vertical profiled wall elements 11 of the vertical frames 10 can rest with a profiled side with a row of fastening receivers against the insides of the fastening edges 23 and can be connected with them.

FIG. 1b shows an alternative embodiment of the cover element 20, wherein the edge 25, 27 is folded by 180°. The edge 25, 27 supports a bearing bush 29 with a bearing receiver 28.

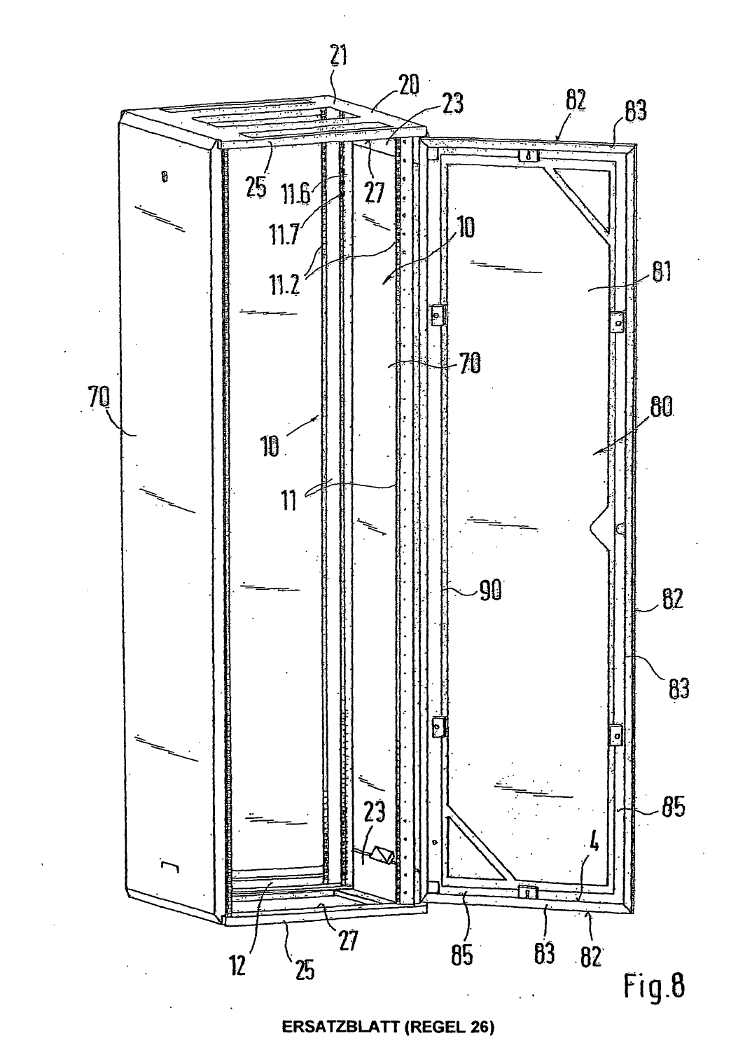

As FIG. 8 shows, wall elements 70 close off the two sides of the basic rack 60, wherein they are fastened on the fastening edges 23 of the cover elements 20. The cabinet door 80 is also beveled at least in an L-shape at the circumference of the door leaf 81, as shown by the circumferential edge 82, 83. The circumferential edge can also be closed by a third bevel section 84, at least over large portions of the circumference, Furthermore, the inside of the door leaf 81 can support a fastening frame 90, which is spaced apart from the circumferential edge 82, 83 and can receive a sealing element. The fastening frame 90 support has receivers and at the same time is used for stiffening the cabinet door 80.

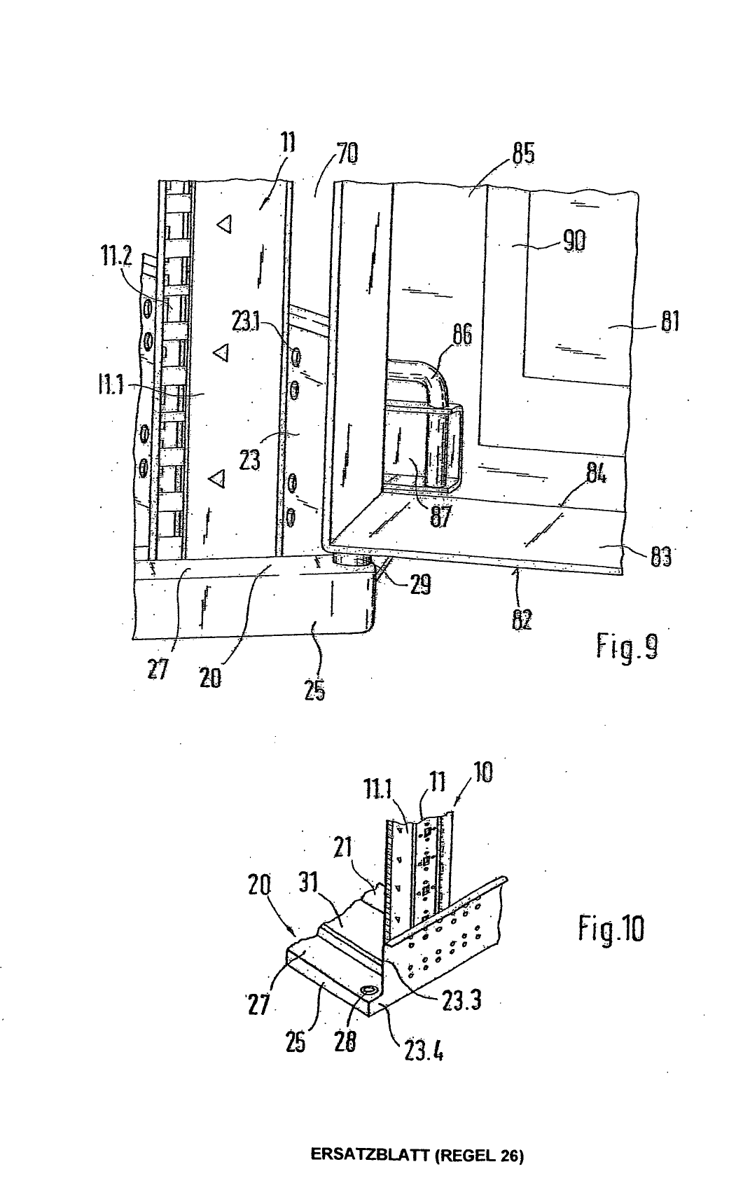

FIGS. 9 and 10 show details of the hinging of the cabinet door 80, wherein the upper hinge point, not represented, is designed correspondingly in a mirror-reversed manner. The cover element 20 protrudes with the bevel edge 25, 27 from the front of the front vertical frame 10 and also from the edge 23.3 of the fastening edge 23 of the cover element 20. In this case, the section 27 of the beveled edge which extends parallel with the base plate 21 can terminate at the edges 23.9 of the fastening edges 22, or can be conducted over a third section as far as the base plate 21. However, the section 27 can reach as far as to the parallel front profiled sides of the vertical profiled wall elements 11 of the front vertical frame 10. Bearing receivers 28 are cut into the two end areas of the beveled edge 25, 27, into which bearing bushes 29 can be additionally inserted.

The corner area of the hinge side of the cabinet door receives a hinge element 87 with adjustable hinge pins 86, as represented by FIG. 9. If in the hinge element 87 of the lower hinge point the hinge pin 86 is set to point up in the position shown, then it does not protrude from the section 82 of the circumferential edge 82, 83. Thus the cabinet door can be placed on the beveled edge 25, 27 of the lower cover element 20 so that the drawn back engagement end of the hinge pin 86 is flush with the bearing receiver 28 or the bearing bush 29 and the same applies correspondingly to the upper hinge point. The hinge pins 86 are axially displaced and their engagement ends are introduced into the bearing receivers 28 or bearing bushes 29 of the beveled edges 25, 27 of the cover elements 20. In this case, the engaged positions, as well as the disengaged positions, or the hinge pins 86 in the hinge elements 87 can be fixed in place or can be released again.

Locking bars, which can be moved manually or by a rod closing device, can be arranged in the area of or near the circumferential frame 82, on the back of the cabinet door on the lock side of the cabinet door 80, and can be inserted into the unoccupied bearing receptacles 28 or bearing bushes 29 of the beveled edges 25, 27 of the cover elements 20 and can be removed again. In this way, the cabinet door 80 can be fixed in place in the locked position, and can be released again from the locked position into the opening position.

In connection with this embodiment, the cover elements 20 are symmetrically designed in their center plane, which extends parallel with respect to the fastening edges 23. This also applies to the center plane which extends perpendicularly with respect to them, so that they can be used as the bottom element and as the top element for the basic rack 60. Thus the corresponding embodiment at the upper and lower hinge points applies to the hinged installation of the cabinet door 80. Regarding the attachment of the locking elements to the cabinet door 80, matters are also the same at the lower and upper cover element 20 and the lower and upper locking position.

1. A kit for producing frame structures for switchgear cabinets, comprising:
a cabinet rack (30) made of four horizontal broad struts (31), four horizontal depth struts (32), and four vertical frame legs (33) of a preset width, a preset depth and a preset height,
plate-shaped cover elements (20) having on two opposite sides fastening edges (23) beveled at right angles with at least one row of fastening receivers (23.1, 23.2),
vertical frames (10) made of two vertical profiled frame elements (11) and two horizontal broad frame struts (12) installable in the cabinet rack (30) and one of connected with the depth struts (32) and attached at different spacings by base profiled sides (11.3) of the vertical profiled frame elements (11) to insides of the fastening edges (23) of the cover elements (20) and with cover elements (20) used as a bottom element and a top element form an independent basic rack (60), and
at least one cabinet door (80) beveled on a circumference and hinged to the cover elements (20).

2. The kit in accordance with claim 1, wherein the broad struts (31), the depth struts (32) and the frame legs (33) of the cabinet rack (30) are formed as sections of respectively identical profiled elements fixedly connected with each other in corner areas of the switchgear cabinet rack (30) by corner connectors (40).

3. The kit in accordance with claim 1, wherein the broad struts (31) and the depth struts (32) of the switchgear cabinet rack (30) form a solid bottom frame and a solid cover frame (35) and the vertical frame legs (33) with the corner connectors (40) form a continuous exterior receiver (36) in the corner areas of the bottom frame and the top frame (35).

4. The kit in accordance with claim 3, wherein the vertical profiled frame elements (11) have a profiled base side (11.3) with at least one row of fastening receivers (11.4) which terminate with front faces of the horizontal broad vertical struts (12), and lateral legs (11.1 and 11.6) are beveled off on both sides of the profiled base side (11.3) which are oriented to longitudinal sides of the associated horizontal broad frame struts (12) of the vertical frames (10) and connected.

5. The kit in accordance with claim 4, wherein at least one row of identical fastening receivers is cut in a uniform aligned graduation into the profiled base side (11.3) and the beveled lateral legs (11.1 and 11.6) of the vertical profiled frame elements (11).

6. The kit in accordance with claim 4, wherein at least one row of equal fastening receivers (11.4, 11.2, 11.7) is cut into respectively the profiled base side (11.3) and the beveled lateral legs (11.3 and 11.6) of the vertical profiled frame elements (11).

7. The kit in accordance with claim 6, wherein the horizontal broad frame struts (12) and the vertical profiled frame elements (11) of the vertical frames (10) are fixedly connected with each other in the corner areas.

8. The kit in accordance with claim 7, wherein the horizontal broad frame struts (12) of the vertical frames (10) have cable guide openings (12.2), and the two vertical frames (10) are connectible by fastening receivers (12.3) of the horizontal broad frame struts (12) with facing tops of the horizontal depth struts (32) of the cabinet rack (30) at different distances from each other.

9. The kit in accordance with claim 8, wherein the base plates (21) of the cover elements (20) have cable introduction recesses (21.2) in the basic rack (60) above the horizontal broad frame struts (12) of the vertical frames (10).

10. The kit in accordance with claim 9, wherein the fastening edges (23) of the cover elements (20) have connecting strips (26) beveled toward an exterior on free edges protrude beyond the base plate (21) of the cover elements (20) over the fastening edges (23) and with the connecting strips (26) form receivers for attaching lateral walls on the basic rack (60).

11. The kit in accordance with claim 10, wherein the base plates (21) of the cover elements (20) protrude at sides extending perpendicularly with respect to the fastening edges (23) and have bevels (25), on which a cabinet door is hinged and lockable, and a fastened rear wall.

12. The kit in accordance with claim 11, wherein the base plates (21) of the cover elements (20) have a center opening (21.2) and fastening bores (22) in the corner areas.

13. The kit in accordance with claim 12, wherein the cabinet rack (30) is formed of an identical bottom frame (35) and an identical top frame (35) which face each other with protruding corner connectors (40) and are connected with each other via the four vertical frame legs (33) to form the cabinet rack (30).

14. The kit in accordance with claim 13, wherein the vertical frame legs (33) of the cabinet rack (30) have a profiled element with a plug-in connection (33.3) for a plug-in element (40.2) of the corner connectors (40), wherein with an exterior contour the profiled element forms the exterior receptacle (36) which is symmetrical with respect to a diagonal plane of the bottom frame and the top frame (35).

15. The kit in accordance with claim 14, wherein the bottom frame and the top frame (35) of the cabinet rack (30) have corner receivers (35.1) into which the corner connectors (40) are placed with a filler element (40.1) and connected with one of the bottom frame and the top frame (35), and with an exterior contour the filler elements (40.1) of the corner connectors (40) extend the exterior receptacles (36) of the vertical profiled frame element (33) of the cabinet rack (30) beyond the bottom frame and the top frame (35).

16. The kit in accordance with claim 15, wherein the front sides (33.1, 33.2) of the vertical profiled frame elements (33) of the cabinet rack (30) are connected upright with the facing sides of the bottom frame and the top frame (35) and the filler elements (40.1) of the corner connectors (40).

17. The kit in accordance with claim 16, wherein the vertical profiled frame elements (33) of the cabinet rack (30) form a channel (33.0) open to an interior of the cabinet rack (30), between the bottom frame and the top frame (35), which is closed by a profiled box (50), and the profiled box (50) has vertical channels (50.1, 50.2) and rows of bores (50.4) in a cover wall (50.3).

18. The kit in accordance with claim 17, wherein the cover wall (50.3) of the profiled box (50) covers the channel (33.0) in the vertical profiled frame elements (33) of the cabinet rack (30) with covering strips (50.5).

19. The kit in accordance with claim 18, wherein a profiled side (33.4) of the vertical profiled frame section (33) forming the channel (33.0) supports connecting strips (33.5) formed on an exterior of the free profiled side (33.6).

20. The kit in accordance with claim 19, wherein the cabinet door (80) has a beveled edge (82, 83) which receives hinge elements (87) with hinge bolts (86), which can be inserted into bearing receivers (28) of the cover elements (20) of the basic rack (60) in the corner areas of the hinge side of the cabinet door (80), and the hinge bolts (86) are adjustable in an axially limited manner in the hinge elements (87) and can be fixed on the bevel (25) of the cover elements (20) against shifting, at least in a position engaged with one of a facing bearing receiver (28) and a bearing bushing (29).

21. The switchgear cabinet in accordance with claim 20, wherein end edges (23.3) of the fastening edges (23) of the cover elements (20) are set back relative to the bevel (25) by at least an amount that at least corresponds to dimensions of a first door bevel (82) directed perpendicularly to a door leaf.

22. The switchgear cabinet in accordance with claim 21, wherein bearing bushes (29) are inserted into the bearing receivers (28) in the bevels (25) of the cover elements (20).

23. The switchgear cabinet in accordance with claim 22, wherein a lock side of the cabinet door (80) has displaceable locking bars which are shifted one of manually and by a rod closing device and are insertable into one of the bearing receivers (28) and the bearing bushes (29) of the bevels (25) of the cover elements (20) of the basic rack (60), and are removable.

24. The kit in accordance with claim 1, wherein the vertical profiled frame elements (11) have a profiled base side (11.3) with at least one row of fastening receivers (11.4) which terminate with front faces of the horizontal broad vertical struts (12), and lateral legs (11.1 and 11.6) are beveled off on both sides of the profiled base side (11.3) which are oriented to longitudinal sides of the associated horizontal broad frame struts (12) of the vertical frames (10) and connected.

25. The kit in accordance with claim 1, wherein the horizontal broad frame struts (12) and the vertical profiled frame elements (11) of the vertical frames (10) are fixedly connected with each other in the corner areas.

26. The kit in accordance with claim 1, wherein the horizontal broad frame struts (12) of the vertical frames (10) have cable guide openings (12.2), and the two vertical frames (10) are connectible by fastening receivers (12.3) of the horizontal broad frame struts (12) with facing tops of the horizontal depth struts (32) of the cabinet rack (30) at different distances from each other.

27. The kit in accordance with claim 1, wherein the cabinet rack (30) is formed of an identical bottom frame (35) and an identical top frame (35) which face each other with protruding corner connectors (40) and are connected with each other via the four vertical frame legs (33) to form the cabinet rack (30).

28. The kit in accordance with claim 1, wherein the cabinet door (80) has a beveled edge (82, 83) which receives hinge elements (87) with hinge bolts (86), which can be inserted into bearing receivers (28) of the cover elements (20) of the basic rack (60) in the corner areas of the hinge side of the cabinet door (80), and the hinge bolts (86) are adjustable in an axially limited manner in the hinge elements (87) and can be fixed on the bevel (25) of the cover elements (20) against shifting, at least in a position engaged with one of a facing bearing receiver (28) and a bearing bushing (29).

29. The switchgear cabinet in accordance with claim 1, wherein end edges (23.3) of the fastening edges (23) of the cover elements (20) are set back relative to the bevel (25) by at least an amount that at least corresponds to dimensions of a first door bevel (82) directed perpendicularly to a door leaf.

30. The switchgear cabinet in accordance with claim 1, wherein bearing bushes (29) are inserted into the bearing receivers (28) in the bevels (25) of the cover elements (20).

31. The switchgear cabinet in accordance with claim 1, wherein a lock side of the cabinet door (80) has displaceable locking bars which are shifted one of manually and by a rod closing device and are insertable into one of the bearing receivers (28) and the bearing bushes (29) of the bevels (25) of the cover elements (20) of the basic rack (60), and are removable.

32. A kit for producing frame structures for switchgear cabinets, comprising:
a cabinet rack (30) including four horizontal broad struts (31), four horizontal depth struts (32), and four vertical frame legs (33), each of a preset width, a preset depth and a preset height, two vertical frames (10) each including two horizontal broad frame struts (12) and two vertical profiled frame elements (11) installable in a cabinet rack (30) and each connectible with the depth strut (32), cover elements (20) including a bottom element and a top element connectible with two spaced-apart of the vertical frames (10) to form an independent basic rack (60), and at least one cabinet door (80) each hingedly attached on one of the cover elements (20) and beveled on a circumference of the at least one cabinet door (80).
